(19) United States
(12) Patent Application Publication
(10) Pub. No.: US 2006/0200455 A1
(43) Pub. Date: Sep. 7, 2006

(54) Search engine result reporter

(75) Inventor: Eric Cameron Wilson, Sunbury (AU)

Correspondence Address: ETHERTON LAW GROUP, LLC, 5555 E. VAN BUREN STREET, SUITE 100, PHOENIX, AZ, 85008, US

(73) Assignee: Redbank Manor Pty Ltd, Ringwood East (AU)

(21) Appl. No.: 10/539,851

(22) PCT Filed: Dec. 22, 2003
(86) PCT No.: PCT/AU03/01706

§ 371 Date: Jun. 20, 2005

(30) Foreign Application Priority Data
Dec. 20, 2002 (AU) 2002953500

(51) Int. Cl. G06F 17/30

(52) U.S. Cl. 707/4

(57) ABSTRACT

A method of reporting search results that preserves important locational information retrieved with the search results. An Hierarchical Data Modeller extracts locational information from each search result and compiles the locational information into a hierarchical storage. In one embodiment, the search results are presented to the user in a Hierarchical Search Result Workflow document that allows the results to be sorted or otherwise processed by the user for maximum benefit.

### FIELD OF THE INVENTION

The invention relates to the sifting of information where an answer to a query on a body of content or information is presented in context with the topical structure of its store or presented taxonomy, also allowing access to summary and descriptive information, discussions and notes and the marking of entries for later retrieval.

### BACKGROUND

Search engines are common in desktop operating systems, corporate servers, databases, within Web sites and dedicated systems surveying the Internet. Much research has been done into algorithms to produce the best set of document titles and locations from a given query to what the user wishes to see. However most systems have assumed the body of content being searched to be largely made up of unrelated documents. On many occasions, this is not true. Content often has an implicit taxonomy not effectively portrayed to users—for example their location in the stores in which they are found.

To be specific, content typically isn't stored in isolation but in collections, such as file system directory hierarchies. Even document titles returned from a search over the Internet are often related this way, coming from the same Web site or the same hierarchical tree within a Web site.

Unfortunately these relationships, which often provide a vital context for assessing a document's relevance, remain largely hidden to end users. This problem has been addressed in the art in relation to the comparatively little amount of content a user has already seen, but not what users are searching to see in future. For example, IBM (U.S. Pat. No. 6,460,060), NEC (JP 2000020536) and Hitachi (JP 11039205) conduct searching or recording of browser caches, presenting results in a hierarchical way. But these all lack the means to efficiently deal with large volumes of results typically returned by search engine queries, the means to query multiple search engines, and the ability to merge different search results together or efficiently update them over time. Therefore all these citations confine themselves to the comparatively trivial tasks of improving the usability of Web browser Bookmarks and Back button behaviours.

Another set of art tries making a Website's table of contents, or its structure, easier to navigate in a hierarchical fashion. These include Silicon Graphics' U.S. Pat. No. 6,199,098 patent and Japanese applications 10-156404 (NEC) and 09-064459 (Mitsubishi). Although useful, improving content tables in particular Web sites is not nearly as advantageous as being able to view the hierarchically sorted results of a specific query, returned from multiple search engines crawling millions of sites, if such a system became available.

For at the moment, each matching item is usually returned by search engines as a discrete entry, in no relational context to other returned entries even though such relationships exist. In fact, search engines often make a stab at predicting relevancy, jumbling the order of entries according to their own ranking systems. But with great care people often place information in folders reflecting a topical structure. Sadly, this locational taxonomy in which an entry is found is only displayed individually as a line item, de-emphasising the intrinsically informative structure in which the results could otherwise have been displayed.

An example of this can be found in Novell Inc.'s ‘Document reference environment manager’ (U.S. Pat. No. 6,081,814). This system recognises the importance of the hierarchical structures in which content is found, even allowing end-users to see or limit the result set by them. And a single search request may be conducted using multiple search engines over multiple sites. Yet ultimately, all that is returned to end-users to select from is a straight ‘List of links’.

In an attempt to overcome this type of deficiency, some Internet search engine companies provide their own folder-like taxonomy, produced by their staff by manually classifying Websites. Although this has some value, such a manual system cannot be expected to classify large volumes of documents or pieces of information individually, only the generality of whole sites or sub-sites.

On a much smaller scale, this manual classification overlay strategy is employed in Kind Code's ‘Displaying hierarchical relationship of data accessed via subject index’ (US Application 20020059210). In this citation, a taxonomy is manually created for accessing row/column database information in a hierarchical fashion. Being a technique applied to small databases running in handheld devices, this search mechanism does not take advantage of the hierarchical structure in which large bodies of information are often stored, or the meaningful paths by which they are accessed. What is lacking is a more general solution which can utilise a number of different search engines, targeting a number of information repositories, where results are presented in the hierarchical context in which they may be accessed.

This means even using today's best search engines, the information's own specific taxonomy is often not available to searchers. Instead, users are forced to scan each returned item representing a possibly relevant piece of information or document separately, evaluating the relevance of each entry one by one. Some applications attempt to reduce this problem by allowing a new search within a set of search results so as to narrow down the entries for manual scanning. However on many occasions it would be much quicker if results from searches were presented in the context in which they were found, making eliminating irrelevant ones much easier. However, even if users were able to simply collapse whole hierarchies of irrelevant results with a single mouse click, much time consuming scanning may still be required to pinpoint the most relevant answers. This is because search engines often return either too much or too little information to make an accurate assessment of the content in question.

For example, just providing matching content titles, dates, creators, owners, price and size allows for quick scanning but not much in the way of evaluating the prior knowledge required to understand the information. For this, a summary might be needed and/or the sentence in which the first match was found. However all this additional information takes longer to process and uses up precious screen space. This can slow down query response times for the end user as information is presented page by page, often also requiring uncomfortable scrolling to read. Searching for relevant answers this way can be very tiring on the eyes, especially on small-screen devices. What is needed is a hierarchical presentation of search results where end users can select the type of result information displayed to them in the first instance.

Internet search engine developers, not end-users, usually decide which result details are rendered and in what order, but end users often have different priorities. For example, one may hold the date of the document to be the all-important factor for relevancy after the match criteria has been met, while another is only interested in the writings of a particular set of authors, no matter how old they are. Some search engines may provide ways of incorporating these criteria but the mechanisms for querying to such granularity, where provided, are universally cumbersome. There is no standardised method of query refinement between search engines.

One example is described in United States patent application number 20020083039, again in the name of Kind Code, which describes an hierarchical data-driven search and navigation system. This patent application describes a system of building a knowledge base of common attributes that characterize materials and then searching through the knowledge base using the attributes. The system relies upon the generation of the attributes, rather than using the existing taxonomy. Such attributes may not be present when querying bodies of material not under the user's control or impractical to implement over large content collections.

Likewise, Novell's ‘Document reference environment manager’, (previously mentioned) might not easily scale to Internet proportions. It relies on attribute-carrying software objects (called ‘DocLocs’) with accompanying tabular datasheets, to represent searchable documents in a catalogue. But for speed and capacity, what is needed is a lightweight classification system—perhaps utilising doubly-linked lists to efficiently reflect irregular hierarchical structures—without the ‘object oriented’ overhead.

With the known search engines the user is confronted with a difficult choice once an item of interest has been found. Links to the information can either be transferred to a favourites list for later reference or the end user can go to the item or document immediately, interrupting their search. Indeed, when using a Web browser, if the user forgets to open the link in a new window, the new document will often replace their search results, possibly before they are done searching. On many occasions, a far nicer way to work would be to mark entries for later reference, with a system for prioritising and reviewing the most interesting ones first.

But simply adding interesting results to a favourites list has its own drawbacks. Because none of an item's summary information is stored in a favourites list, the user is forced to rely only on the title for guidance as to what the favourites' link actually refers to. And if a user moves to a different machine or network, their favourites-based search results list may not be transferred, forcing them to start over. And a favourites list has no easy way to store the user's ranking of an item's interest, to guide the order of later review.

As a favourites list grows large, users sometimes forget where they placed links or which links refer to what items. It would be useful if the search for these documents did not have to start over, but could somehow be limited to a population of previously book-marked or flagged documents.

It would also be useful if the order in which items of interest are examined wasn't so difficult to manage. Search results or documents marked for later reference should be able to be further modified using a quick sort process. For example, a user might find longer works of many words or of many diagrams to be of particular relevance, however the favourites or search results lists cannot be easily resorted this way, even though all the information may be at hand to do so.

The act of searching naturally leads to note taking or even discussions as items of interest are found. Despite this obvious user requirement, today's search displays tend to be ‘read only’, lacking an easy way of creating and managing integrated multi-user annotations.

Scanned search results may also comprise a valuable resource which is simply being discarded after use. This means if a user wants to keep abreast of a particular area, they must manually remember the date and query parameters of their last search and perform the procedure again. Combining the results of multiple searches for cross matching or joining results, though sometimes highly desirable, is difficult to achieve using today's search engines. Even switching off a machine and later coming back to the search exactly where you left it involves retracing old steps. And it is difficult to secure end-user notes to each viewed result for later reference.

Additionally, different search engines return different results and different sets of details. This lack of standardisation makes definitive searches across large bodies of information from different sources rather elusive. In a user-friendly world, it would be the end user not the search engine provider or developer who decided exactly how results should be collated and presented.

In summary, search engines have been built to efficiently use IT resources rather than being designed around actual human workflows. This means they often waste user time in finding the required answers and are even more inefficient in determining if the desired information does not exist within the collection being searched.

### OBJECT OF THE INVENTION

It is an object of the invention to render search results in a manner preserving the hierarchical context in which they are stored or classified by information owners, allowing fast elimination of irrelevant answers.

It is a further object to provide additional information about the document when requested, saving space and increasing speed, without distracting the user from the hierarchical context in which the content records are presented

It is a further object to provide a mechanism to record and sort the interest a user has in such documents.

Further objects will be evident from the following description.

### SUMMARY OF THE INVENTION

In one form, although it need not be the only or indeed the broadest form, the invention resides in a method of reporting search results including the steps of:
retrieving search results from one or more search engines;
filtering the retrieved search results according to one or more criteria;
extracting locational information from the filtered search results;
storing the locational information in one or more output hierarchies; and
displaying the search results within the one or more output hierarchies.

The step of extracting locational information may involve analysing a URL of each search result, analysing a file system location, or analysing a taxonomy of the search result.

In a further form, the invention resides in a method of compiling and presenting search results including the steps of:
defining search parameters for submission to one or more search engines;
passing the search parameters to a search engine submitter;
said search engine submitter transforming the search parameters to search terms for each of said one or more search engines;
receiving results from said one or more search engines;
said search engine submitter transforming said results into standardised results having a standardised format;
passing the standardised results to a location analyser;
said location analyser filtering the standardised results according to criteria to produce filtered results;
passing the filtered results to a hierarchical data modeller;
said hierarchical data modeller extracting locational information from said filtered results;
compiling said locational information in an output hierarchy; and
displaying the filtered results within the output hierarchy.

In a yet further form, the invention resides in a search result reporting engine comprising:
a location analyser means that filters search results received from one or more search engines according to one or more criteria; and
an hierarchical data modeller means that extracts locational information from the filtered search results and compiles said search results into output hierarchies based upon the locational information.

In a still further form, the invention resides in an hierarchical data modeller comprising:
means for extracting location and meta information from a search engine result set;
means for compiling the location and meta information into a N-way hierarchical storage location; and
means for retrieving like information from the storage location.

### BRIEF DESCRIPTION OF THE DRAWINGS

In order to assist in understanding the invention a preferred embodiment will be described with reference to the following figures in which:

FIG. 1 is an overview of Search Workflow and shows how components of one embodiment of the invention relate;

FIG. 2 outlines the Report Renderer process which formats the search results in the output hierarchy for viewing by the user;

FIG. 3 outlines the Search Engine Submitter process which allows the asynchronous querying of multiple search engines so results can be returned to the user before all engines have replied to the request. The search engine submitter also transforms results into a standardised format suitable for the Location Analyser;

FIG. 4 outlines the Location Analyser process which removes duplicate results from multiple search engines before encoding unique entries into hierarchical form using the Hierarchical Data Modeller. This processing may be conducted asynchronously to result display and manipulation;

FIG. 5 outlines the Hierarchical Data Modeller process which encodes information contained in a search result into a hierarchical format, preserving the publisher's taxonomy for later use;

FIG. 6 displays the Hierarchical Search Result Workflow as an embodiment of the user interface of the invention, showing how retrieved information is presented in hierarchical form and the means by which it may be manipulated;

FIG. 7 shows a partially collapsed Hierarchical Search Result Workflow with two topical trees collapsed;

FIG. 8 shows the Hierarchical Search Result Workflow of FIG. 6 with summary and detail exposure demonstrating how result details and summaries can be viewed without breaking workflow of the user;

FIG. 9 shows the Hierarchical Search Result Workflow of FIG. 6 with notes and comments exposed to demonstrate how end-user notes and online discussions can be viewed without breaking the workflow of the user;

FIG. 10 shows the Hierarchical Search Result Workflow of FIG. 6 with end-user sorting to demonstrate how end users can modify the order of entry and folder presentation using sorting, including the modification of result hierarchies with additional sort-based folders;

FIG. 11 shows the Hierarchical Search Result Workflow of FIG. 6 with prioritisation of a previously sorted set of results according to user judgement; and

FIG. 12 shows Flagged Folders & Entries Workflow which shows interoperability and standard operation between the Flagged Folders & Entries Workflow and the Hierarchical Search Result Workflow.

### DETAILED DESCRIPTION OF DRAWINGS

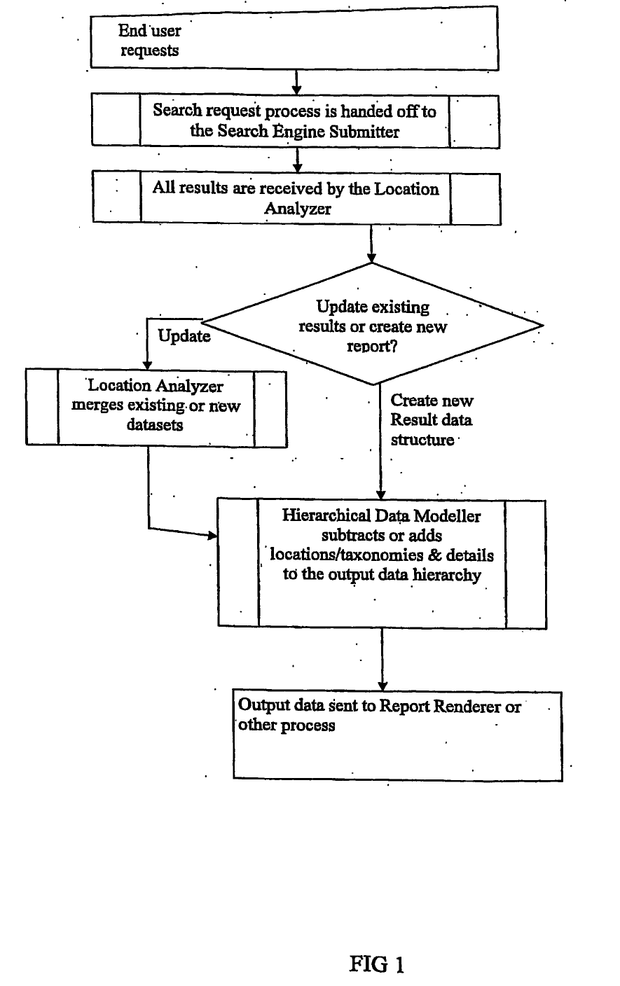

In the simplest form, the first step in obtaining search results on a given query (as shown in FIG. 1) is defining the parameters of the search so as to exclude or include the various desired entries. For example, a user may enter the string ‘Online, Money’ into a field to find all matching entries containing the words ‘online’ and ‘money’ from the default search engine. To query multiple search engines simultaneously, a number of search engines could be selected from a list, including those documents contained in the results of a previous search.

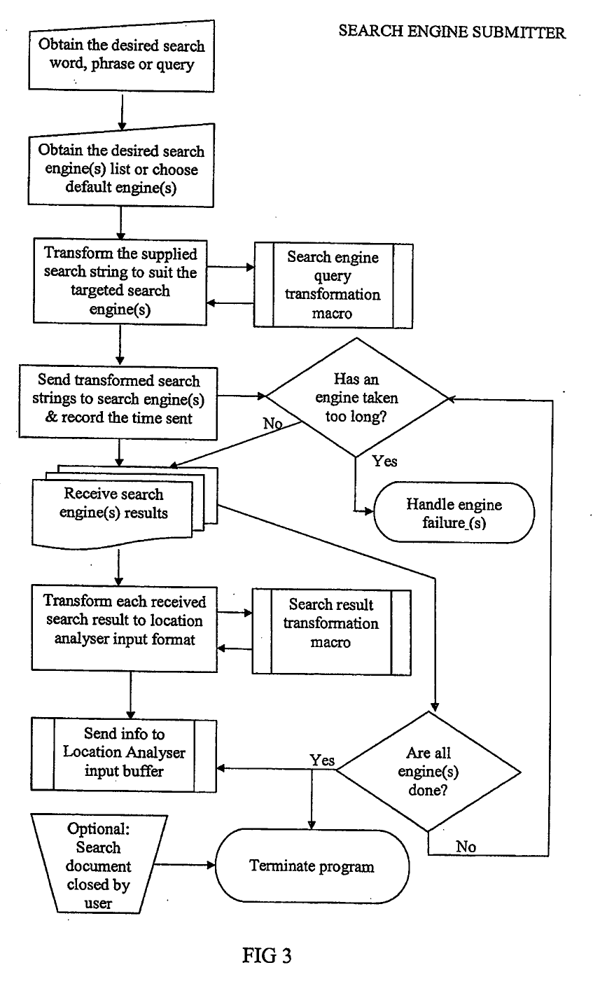

If multiple search engines are to be queried the search request is handed of to a Search Engine Submitter as described with reference to FIG. 3. If only a single search engine is to be used there may be no requirement to invoke the Search Engine Submitter.

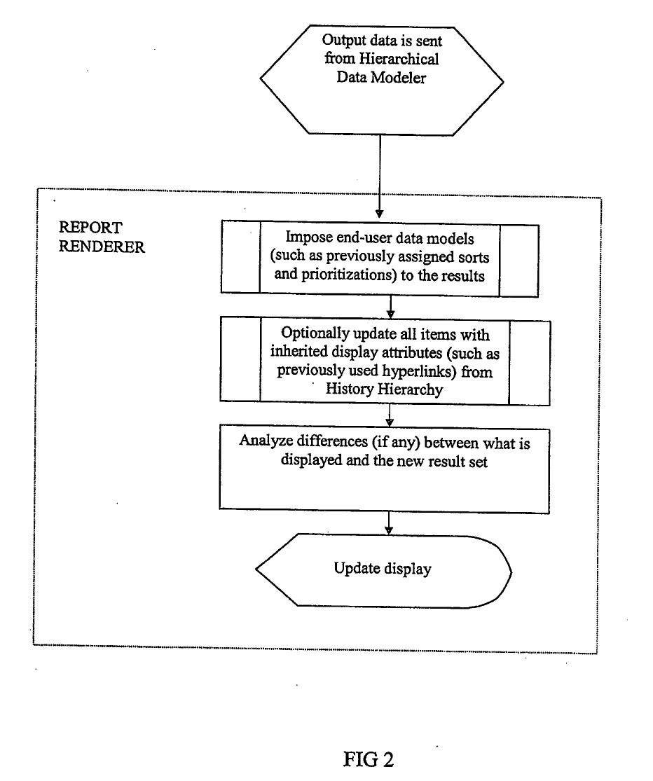

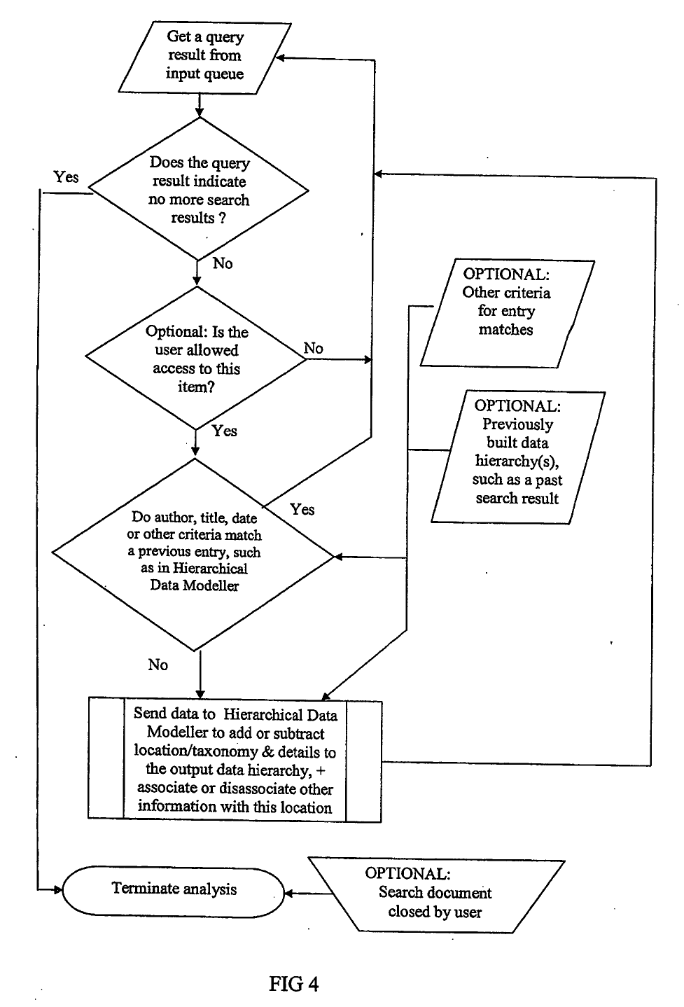

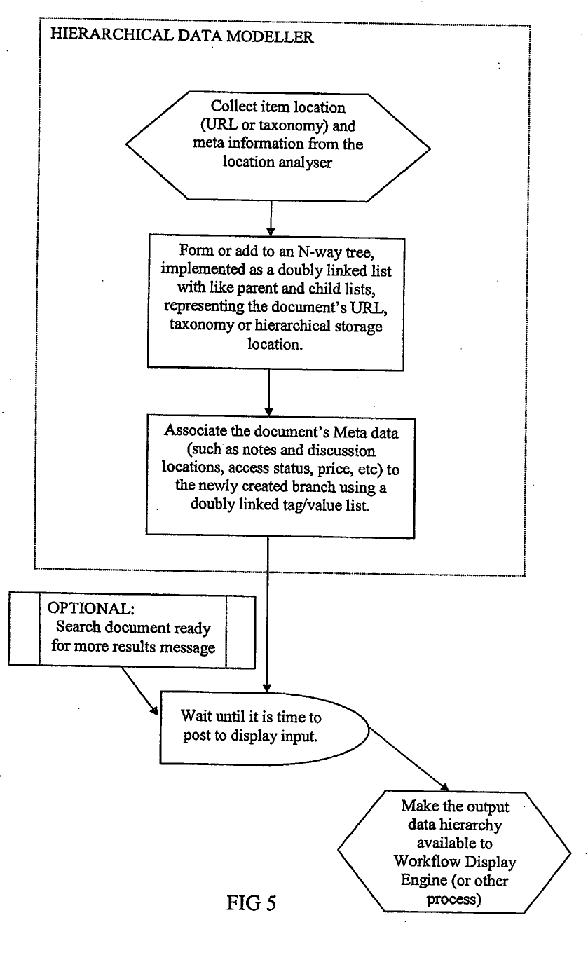

The primary elements of a Reporting Engine to usefully display search results while preserving locational information are a Location Analyser (FIG. 4), which filters search results from the one or more search engines according to various criteria, and a Hierarchical Data Modeller (FIG. 5), which extracts and compiles useful locational information to provide an enhanced display of the search results. The Location Analyser and Hierarchical Data Modeller are described in greater detail below. The output from the Reporting Engine is formatted for rendering on an appropriate display device by a Report Renderer (FIG. 2).

The Search Engine Submitter is shown in greater detail in FIG. 3. This contains search engine query macros, designed to transform the system's own search engine query format into that native of each of the search engines to be queried. Sending off multiple queries itself introduces additional complexity, in that the target search engines will most likely respond at different times, at different rates, with results in different formats. Indeed, some search engines may be offline at the time, in which case a time out may raise a message to the user that a particular search engine's results were unavailable (and thus not incorporated into the matching answers) at the time of querying.

Limits on the number of results accepted from a particular engine may also be imposed, although with the system's efficient hierarchical manipulation and presentation mechanisms, this capability is not as important as would otherwise be expected.

Once results have been received, they are transformed from their native search engine-specific format into a standardised line-item format understood by the system's Location Analyser. After all results have been sent to the Location Analyser, the Search Engine Submitter process is terminated or reset for the next batch of requests. This can also be triggered before the process has finished dealing with or waiting for results, such as when an end-user manually cancels the search.

When results are passed to the Location Analyser (FIG. 4), they are checked to make sure they are not duplicate entries of those presented previously to the Analyser pertaining to the search in question. (Several instances of the Location Analyser may be run at once by the system for different purposes.) Optionally, other criteria for matching could be provided, such as but not limited to:
1. Where the entry is not one which is found in a previous result hierarchy;
2. Where the entry has the same name and location but is an updated version of an entry in a previous result hierarchy;
3. Where the entry is a duplicate of that found in a previous result hierarchy.
4. Where aliases or shortcuts are used in the paths or names used to access content

In order to facilitate this kind of comparative matching, previously built data hierarchies may optionally be loaded into the output hierarchy or be used as the basis for making such comparisons. In this way, the location analyser can be used to merge two different result hierarchies together, removing duplicates or highlighting the commonalities between them.

Optionally, if the user has been granted access to the item—such as indicated by file system privileges, or membership of a group of users authorised to access the returned item, or some other authorisation check—the item's location and details are added to the Location Analyser's output hierarchy. This is achieved using the Hierarchical Data Modeller (FIG. 5).

The Hierarchical Data Modeller breaks down the item's hierarchically based URL, file system location or supplied taxonomy into discrete segments to form or add to an N-way tree, implemented as a doubly linked list with like parent and child lists. These represent the documents URL, taxonomy or hierarchical storage location. For example “http:/dogs.com/behaviours/barking/how to stop.html” could be broken into four separate segments, being dogs.com, behaviours, barking and ‘how-to-stop.html’. These are each encoded into a doubly linked list structure as parent and child lists, to preserve the reference's hierarchical nature (while allowing quick navigation across the resulting data trees generated from multiple answer entries).

The next child list contains the item's properties or ‘meta data’, such as the name of its owner (or use-before date, price etc.), which if there were more than one could itself be further represented as a child doubly-linked list. (Doubly-linked lists are a well documented data structure, commonly used in the computer programming field.) It's in this metadata area that a reference may be made to associated information, such as the location of group discussions or end-user notes about the item. This is discussed in more detail below.

The use of such linked lists rather than common table structures or software objects is a more efficient method for storing and manipulating arbitrarily shaped trees of intrinsically hierarchical data. This makes comparing stored entries with fresh entries coming into the Location Analyser much faster, as the resulting data structure is more concise, with fewer entries to scan before making a given determination. The efficiency of the system's scanning speed becomes paramount when multiple search engines provide hundreds of possible entries at different rates, which each need to be compared to avoid presenting duplications to the end-user.

Even though doubly-linked lists may be the preferred embodiment of the invention's underlying data structure, it should be noted the other storage methods may also be employed with the invention if so desired. For example, instead of using doubly linked lists in memory, a more inefficient yet persistent method could be used, such as an XML text file on disk.

Optionally, the Location Analyser can be used to remove duplicate entries reported at different locations. For example, if two items have the same title, date, author and length, it is most likely one is a copy of the other. Rather than report two separate locations, only the first might be reported, or perhaps the one where the most other matches occur, or a random or other selection criteria may be applied.

It should be noted however that a duplicate entry may be indicative of entries having legitimate multi-purpose contexts, in which case cross-location de-duplication may be inappropriate. An example of this would be where an item called ‘Dogs-in-the-cold.html’ could appear under ‘//Animals/K9/Dogs in the cold.html’, “//Transport/Animal powered/Antarctica/Dogs in the cold.html” and ‘//Hobbies/Pets/Dogs in the cold.html” hierarchies. Therefore this feature is preferably implemented under end-user control because even if duplicates are allowed, this hierarchical presentation places little extra burden on the end-user to manually sort. For example, if a user is interested in Antarctic transportation, the Hobbies and Animals categories mentioned could be quickly collapsed if deemed inappropriate.

Results added to the Location Analyser's output hierarchy may be sent to Report Renderer (FIG. 1), in batches or when requested. This is because inserting hierarchical information into a display is computationally expensive, so it's often better to do entries of near proximity in a tree together rather than random individual updates. However if the system detects its CPU is idling anyway, it may process and insert information into the display as it becomes available.

How this is done depends on whether it is creating a new search or updating an existing search with fresh results. The latter occurs when a user has executed the search previously, has saved it and run it again, when the results of one search are being combined with or subtracted from another or when some but not all results have yet been displayed, such as when one search engine takes longer to answer than another.

The Report Renderer may format, translate or substitute characters when rendering hierarchical namespaces for better readability. For example, according to end-user preference, ‘Dogs-in-the-cold.html’ could be simply rendered as ‘Dogs in the cold’.

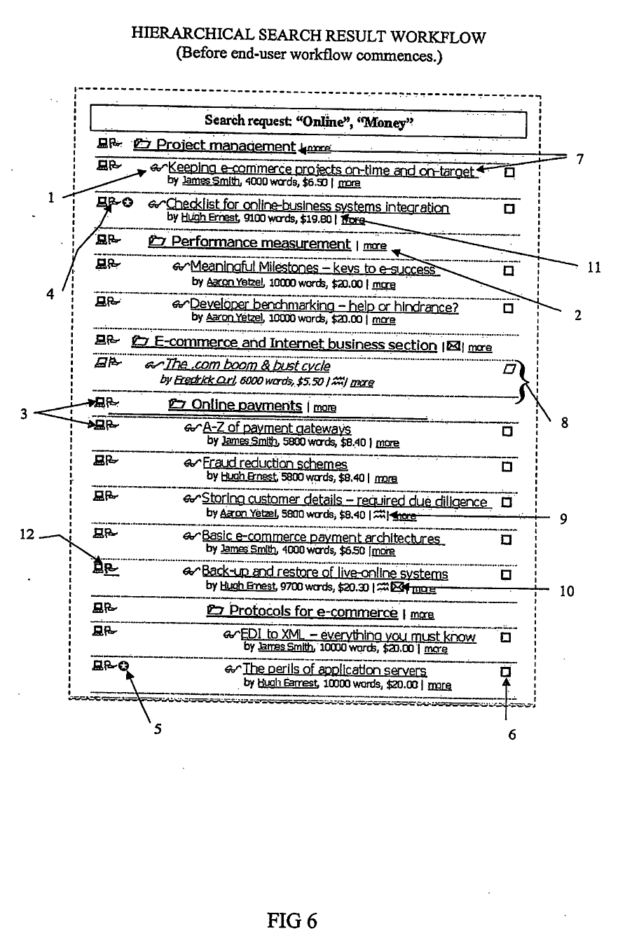

In one embodiment of the invention, the aggregated query results are presented by the Report Renderer in a working document application called a Hierarchical Search Result Workflow. FIGS. 6 to 12 illustrate how Workflow Application Documents, preferably with features common to all search results, end-user custom Favourites and Flagged items hierarchies, allows users to control, sort, store and prioritise search results.

The processes described above may in some situations be optimally executed in a different order. For example, it may speed the process to check if the user has permission to view the entry as a prerequisite for handing it off to the Location Analyser. Illustrated in FIG. 4 is this evaluation being done within the Location Analyser. But optionally, a restricted entry could still be added to the resulting output hierarchy but flagged as restricted as a piece of associated metadata as previously described.

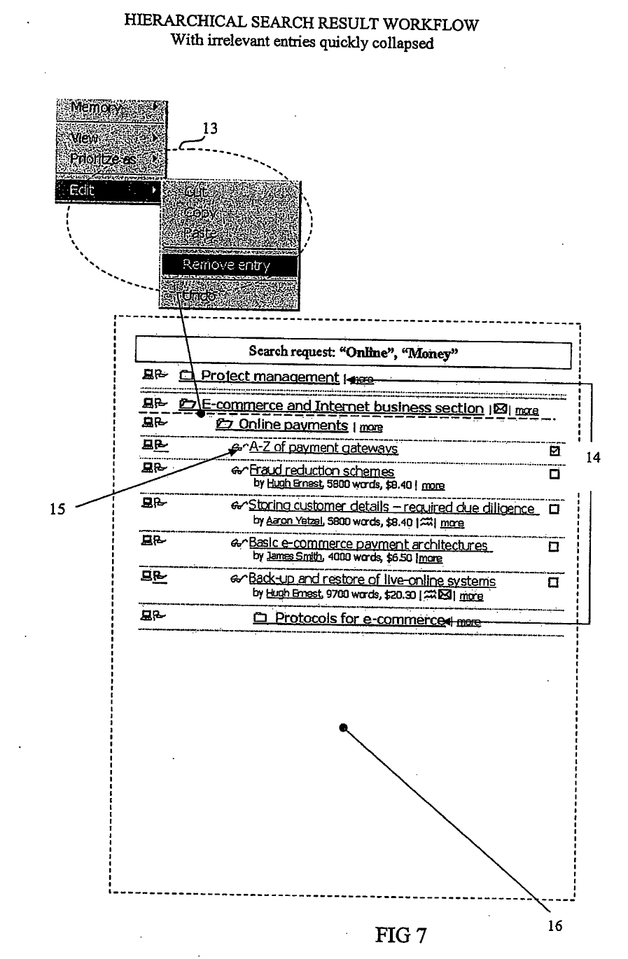

An example of a full listing of results found matching a search is presented as hierarchies for easy manipulation as shown in FIG. 6. (For the sake of illustrative brevity, this has only 12 matches from five locations. Typically, many more matches could be accommodated by scrolling the screen or skipping to the next screen page.) FIG. 6 shows when immediately after a search is returned, at the user's control are:
1) An icon (in this embodiment shown as a set of glasses) to insert a summary of the item in a popup window or beneath the entry. This saves space by limiting the information presented at first to the bare essentials, yet allows instant access to further detail if required. Optionally, further space can be saved by making the summary display area scrollable or suitably paginated. The source of this information may be a supplied summary, such as one found at the head of a document or attached in its properties, the first few sentences or paragraphs of a document, or the sentences or paragraphs surrounding one or more occurrences of the matched word or phrase. Summary information could also be a picture or other graphical representation of the returned item. According to preferences configured by the end-user, any combination of the above information may be displayed in the summary and in any order.
2) An icon (in this embodiment shown as a ‘more’ hypertext link) to display descriptive information about the item in a popup window or beneath the entry. This saves space by limiting the information presented at first to the bear essentials, yet allows instant access to further detail if required. Optionally, further space can be saved by making the summary display area scrollable or suitably paginated.
As with the summary information, this could be taken from a list of properties associated with the item, a database or text file entry or in the case of the returned item being a document or some kind of textural content, from information contained within the referred item itself.
Descriptive information displayed in this space could also itself be presented as a collapsed hierarchy or rendered in some other optional form, conserving display space to be used for only those details deemed relevant by the end-user.
The descriptive information offered to end users can be dynamic, depending on what is found in the item's metadata encoded by the Data Modeller within the doubly-linked list(s).
3) A hierarchy action icon (in this embodiment, shown as a computer silhouette), which when clicked, reveals a popup menu for hierarchical sorting and saving options. Some of these are shown in FIGS. 7, 10 and 11.
This control also allows end-users to specify which pieces of information are presented when the hierarchy is first rendered and which are to be shown through the summary and detail views, and in what order they should all be presented. FIGS. 6 to 12 show this as being currently set to the Item's name, creator, size and price to display on the workflow document when it is first rendered.
4) A Flag icon to flag an item for later reference. Clicking on this adds the item with its hierarchical context (the folders or categories under which it is found) to the flagged entries list. This can also be done by using the menu structure activated by the Hierarchy Action icon. Clicking on the Flag icon again may remove the entry from the list.
This feature assists users by allowing them to collapse hierarchies they have sifted to liberate screen space, while maintaining a reference to Items in a collapsed hierarchy of further interest. Where a user only remembers having seen an entry of interest and flagging it, but not the name of the entry or position in a hierarchy, a new search can be specified, with the entries in the flagged list forming a constraint in the scope of the search.
5) The Interface also provides the ability to add entries to a favourites list which is a custom hierarchy created by the user. In this way, users can create their own taxonomies which themselves are searchable, as like the flagged entries hierarchy (or any previous search result for that matter), can form the basis of constraining exclusion or inclusions In further searches. FIG. 6 shows an item previously added (perhaps using another search) to the Favorites Hierarchy
marked with a star This may be clicked to, go to the corresponding entry in the Favorites Hierarchy.
6) Each entry has a “Done With Item” checkbox. When checked this removes item details and any open summary or detail box or window, while still leaving the first line of the entry visible. Optionally, it may also change the colour of the done item's text. In this way, the ‘Done Item’ checkbox allows users to mark off investigated entries, without removing them from view in case later reference to them is required.
7) Clicking on the first line of an entry takes the user to that entry. Clicking on a hierarchy folder entry collapses or expands that folder.
8) Previously clicked on hierarchy folders or items are given a different colour, as an indication of the users previous visit.
9) An end user note icon (in this embodiment represented as squiggly lines) indicates by its colour if notes are present. If so, clicking this exposes the notes list below the item or hides an exposed notes list. One way to add notes to an item, hierarchy or search in this embodiment is through a pop-up menu accessed using the Hierarchy Action icon. End-user notes allow users to attach their own private remarks to entries for future reference.
10) A discussion icon (which in this embodiment looks like the back of an envelope) exposes a discussion hierarchy when clicked. This allows the user to see other people's comments about the returned item, assisting in the process of judging its relevance.
11) Addition details about the item, optionally as requested under end-user control.
12) A Previously Flagged icon denoting the user has clicked on this icon to flag this entry, (while reviewing this set of results or a previous set), for future attention. Clicking on this icon now will unflag the item (putting the icon back into its unflagged state) and remove its reference from the flagged items hierarchy.

FIG. 7 shows how search results can be quickly narrowed down to those most relevant to the user. Over half the entries have been eliminated using just three clicks. Two collapse hierarchies while one removes an item deemed by the user to be irrelevant. But although through this process many items are no longer displayed on the screen, they do remain in the workflow document application's doubly linked tree list structure for future reference, should the user require them.

The figure shows how the “.com Boom & Bust Cycle” entry (shown in previous figures) has been completely removed using the pop-up workflow options menu 13 accessed via the entry's Hierarchy Action icon.

Two topical folders have been collapsed 14 by clicking on them without requiring users to scan individual entries for relevancy. An entry has been collapsed 15 by checking the ‘Done with entry’ checkbox on the right. These actions have liberated screen/document space 16 which for longer searches could be used to contain more folders and entries.

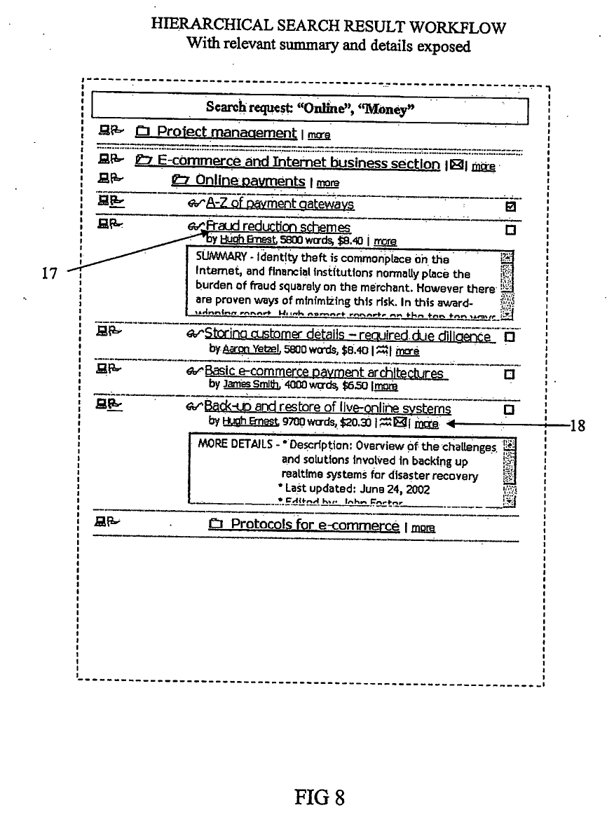

FIG. 8 shows how summary and additional details can be displayed by clicking on their corresponding icons. Clicking their icons again will hide this additional information once more, allowing the user to continue scanning the search without going back and forth between applications. For an implementation of the invention using a Web interface, a similar effect may be accomplished launching a popup window from an entry or folder's Detail or Summary icon. Not shown in the diagram is a folder with a summary icon, which is possible if a search engine also provides a summary of a folder's contents as part of its results.

In FIG. 8, the summary icon 17 was clicked to show a summary. If the icon is clicked again, the summary is hidden from view. Also, the more icon 18 was clicked to show additional details not shown in the detail line. If the icon is clicked a second time, this detail will be become hidden again.

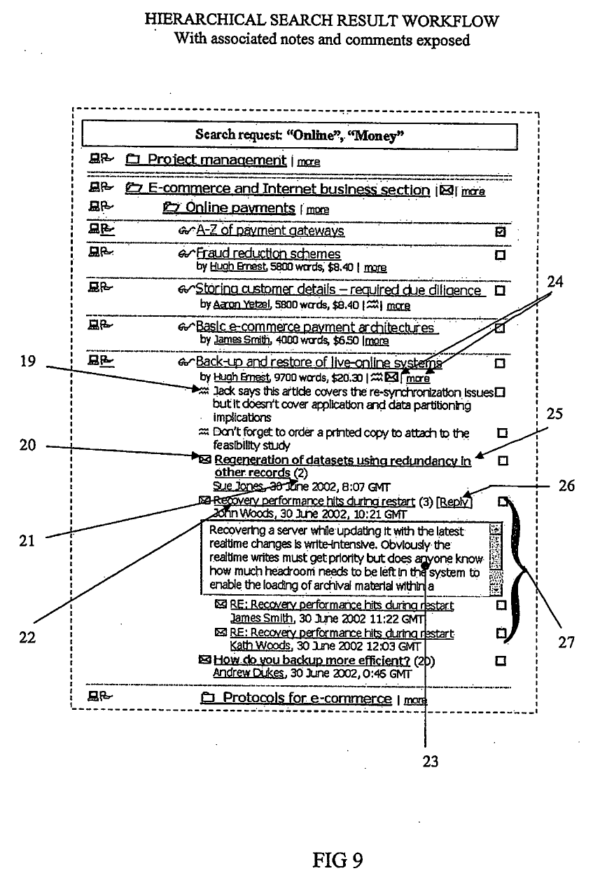

FIG. 9 shows how notes and discussions fit into the workflow application document. Notes are attached to the workflow application document. This means they can only be shared with others if the workflow application document itself is shared. Discussions are attached to the item hierarchies themselves, either within an organization or on a publicly accessible server, meaning they may appear in many workflow application documents simultaneously.

In this particular embodiment, each exposed note has its own Note icon (a set of squiggly lines) which can be used to hide or show all but the first line of the note, which is always in view so long as the returned item's Note list is open, as controlled by the main Notes icon in the item's detail line. Optionally, long notes may also be displayed in a popup menu or (perhaps scrollable) text box.

In this implementation, notes may be added to folders or returned items using the popup menu accessed from the Hierarchy Action icon. In this way a note may also be added to the search title itself, allowing the recording of notes pertinent to the search as a whole. Thus the system makes note taking integral to the search process, allowing users to add value to their workflow application documents, which themselves could be passed on to other users in a collaborative environment.

Discussions work differently, in that they form a hierarchy of comments, with replies appearing under the comment prompting the exchange. Therefore by way of example, in this implementation (though K is not the only implementation), the comment header (subject line) has a dual purpose; When a message header is first clicked, it shows the discussion hierarchy (the responses to the comment and their respective responses to responses) underneath it. The number of these in total is indicated by the comment count, shown in brackets after the message header. On the second click of the header (or on the first click if there are no responses), the comment is shown and a Reply icon appears just after the comment's header.

When a search is refreshed (optionally automatically upon opening the document), additional discussion items may be added into the hierarchy. Optionally, when a search document is open, it may poll the server hosting relevant discussion hierarchies for more comments from time to time. A user may also add a discussion hierarchy to their favourites list using the Discussion icon to the left of the discussion header.

When notes, discussion hierarchies and the comments within them have been opened, they may be optionally presented in a different colour as an indication of their prior viewing. Notes and discussion hierarchies also each have a ‘Done’ checkbox, giving users a visual way of indicating if an item does not deserve revisiting.

The effect of clicking the various note and comment icons is shown in FIG. 9. The various areas of the display show a note 19, a comment hierarchy 20, and an indication of the number of messages in a comment hierarchy 21.

Clicking on a message header 22 hides the message if shown, otherwise it collapses Comment Hierarchy. An open Comment Hierarchy message 23 is shown by a second click on message header, if the header has hierarchy underneath; otherwise it opens on first click.

The icons which have been clicked to display notes and comments in the hierarchy below can be clicked again to hide these hierarchies 24.

Whether a comment Hierarchy has not yet been read is indicated by the coloration 25.

When message is opened a Comment Reply link 26 is added.

The figure also shows 27 how an Open comment hierarchy is expanded by first clicking on top message header.

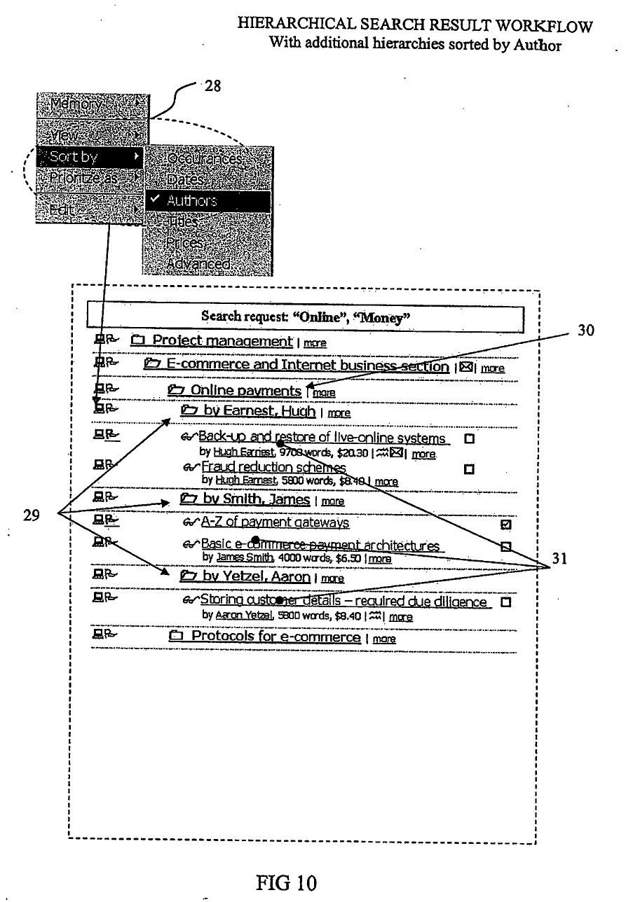

FIG. 10 shows the additional hierarchical structure added beneath a folder after a sort option has been applied to it by an end user. In this implementation, this is done by clicking on the folder's Hierarchical Action icon. The example figure shows the items now appearing under automatically created ‘author’ folders. (If the items were in subfolders, the subfolders could also optionally appear under the author folders, thus maintaining the items original context while still showing it under its author folder.) Optionally, the items may be sorted without the creation of additional sub folders, such as applying a simple date order to a folder or hierarchy.

Optionally, sorting applied to a search workflow application document will also be automatically transferred to corresponding entries (if any) in the Flagged Items hierarchy, and visa versa.

After clicking the Hierarchy Action icon a preference selection may be made from the menu 28. As a result of the preference selection 28, extra Author folders 29 have been automatically inserted into the hierarchy. A folder (and optionally its sub folders) is now sorted 29 by the preference selection in (28). Optionally, other folders and entries not referenced by the Hierarchy Action icon selected remain unchanged.

In (31) the figure shows how items 31 are now sorted according to the preference selection 28, with their entries now appearing under an automatically created hierarchy.

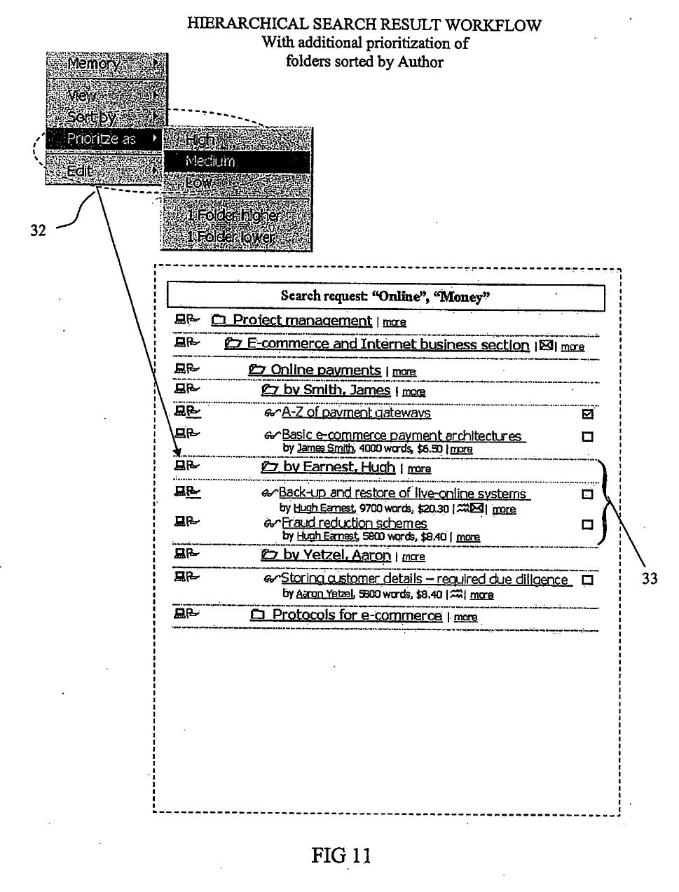

FIG. 11 shows how end-user prioritisation can be added to a search using the workflow application document, the example in the figure showing this after the author sort. In this implementation, priority can be added by promoting a hierarchy or item to one position higher in relation to its sibling folders or items. Items or folders can be demoted by moving them one position down in relation to their sibling items of folders. Alternately, this implementation allows items and folders to be repositioned to the middle, top or bottom of their peers by accessing High, Low or Medium prioritisation from the popup menu.

Menu item 32 shows how a former top folder amongst its peers is now demoted by a new prioritization applied via its Hierarchy Action icon, when compared with FIG. 10.

Items 33 show how a folder and entries are still sorted by Author but the Author's priority levels have been adjusted in the hierarchy according to end-user preference.

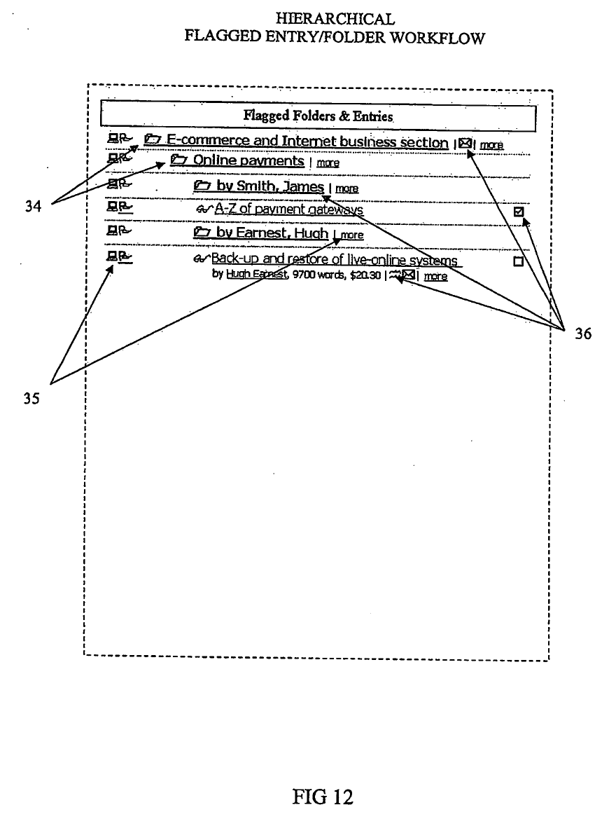

FIG. 12 shows the folders and entries which have previously been flagged. The figure shows how optionally, prioritisation applied to a search workflow application document may also be automatically transferred to corresponding entries (if any) in the Flagged Items hierarchy, and visa versa.

Prioritisation can also be applied to the Flagged Items and Favourites, moving an entry beyond the scope of its peers. This is useful for creating to-do lists, where entries appear strictly in their order of importance to the end user. In the favourites Hierarchy, the user is free to move an entry to any position in any tree they wish, being their own arbitrary entry storage space. But in the flagged documents hierarchy, moving an entry above or below its peers in the tree in preference creates a copy of the hierarchy to be moved with it—preserving its topical context.

So in FIG. 12, if the folder “by Earnest, Hugh” were to be reprioritised above the first folder in the list, a duplicate hierarchy would be created to contain it. This means the modified Flagged Folders and Entries hierarchies in FIG. 12 would now contain two “E-commerce and internet business section/online payments” entries, the first with a “by Earnest, Hugh” subfolder and the second with a “by Smith, James” subfolder.

It should be noted the Search Result, Flagged Folder or Entry and Favourites Hierarchy user interfaces in this embodiment are identical (See FIGS. 12 & 6).

In (34) the figure shows how a hierarchy is preserved so flagged entries remain in their topical context.

In (35) the figure shows how a similar operational metaphor is used in the Flagged items hierarchy as in a Hierarchical Search Result workflow document.

In (36) the figure shows how a similar operational metaphor is used with associations, sorting, prioritizations and Done checkboxes, which in preference interoperate between Hierarchical Flagged Folder/Entries and Hierarchical Search Result workflows.

Thus the system unifies the user experience across multiple search engines as well as the digestion of search results. Similarly, the hierarchical data structures underpinning these Workflow Application Documents are also very similar. This allows the use of the location analyser to merge, extract or subtract entries contained in multiple search results, Flagged items or Favourites hierarchies, to create new Workflow Application Documents.

The Report Renderer can also prioritise items in order of hierarchical branch weight, with those hierarchies having a greater number of matching entries considered to have greater relevance.

The Report Renderer may also initiate automatic horizontal (and vertical) scrolling as hierarchies are expanded and collapsed, to optimise the use of available display. This feature may also be placed under user control, allowing the display area to be optimally focused on the particular hierarchical search results of interest.

Typical Search Workflows

The previously described search result aggregation and interface apparatus enable highly efficient end user workflows to occur in relation to searching, analysing and obtaining information. Here are some typical end-user scenarios enabled by this invention:

Scenario 1

1. The end user types a word or search phrase into the search query interface
2. The end-user selects target search engines from a list
3. The end user collapses 12 irrelevant hierarchies
4. The end user views 5 summaries and flags 3 documents
5. The end-user performs another search, repeating steps 1 to 4
6. The end user switches to the Flagged Folders and Entries hierarchy
7. The end user sorts the items by date using the Hierarchy Actions popup menu
8. The end-user clicks on the two most recent entries, finding the sought after information in seconds
   Scenario 2
1. The end-user types in a word or search phrase into the search query interface
2. The end-user selects target sites or document locations from a list
3. The end-user immediately spots 3 relevant hierarchies
4. The end-user saves them to the favourites hierarchy
5. The end-user opens the first document, finding it highly relevant
6. The end-user views some associated discussions, finding the author has been highly praised
7. The end-user switches to the favourites hierarchy and sorts it by author
8. The end-user views other entries by this author under its newly created hierarchy
   Scenario 3
1. The end user receives a Workflow Application Document from a colleague which has already been checked for relevant entries
2. The end-user types in a word or search phrase into the query interface
3. The end-user selects “Excluding” into the search query
4. The end-user picks the colleague's Workflow Application Document from a list
5. The end-user types a ‘*’ or selects ‘All Results’ into the query interface
6. The resulting hierarchy contains all matching results from the system's default locations except those already found in the colleague's Workflow Application Document
7. The end-user flags interesting looking entries after reviewing their additional details
8. The end-user switches to the Flagged Folders and Entries Workflow Application Document.
9. The end-user views the summary information in the Flagged Folders and Entries Workflow Application Document connected to each entry, prioritising it as ‘High”, “Medium” and “Low” or deleting it from the hierarchy
10. The end user shares or e-mails the Flagged Folders and Entries Workflow Application Document to another colleague who clicks on each entry to access the required information
   Scenario 4
1. The end-user enters a “*” or selects “All Results” into the search query interface
2. The end user selects a target Web site, such as “dogs.com”
3. The resulting hierarchy is effectively a site map of dogs.com, now in a contained in a Workflow Application Document for easy scanning and evaluation
4. The end-user shares or e-mails the Workflow Application Document to a colleague to complete scanning the search
   Scenario 5
1. The end-user enters a “Dog” into the search query, and checks the ‘all word forms’ checkbox
2. The end-user selects two different Workflow Application documents
3. The end-user selects “Excluding” into the search query
4. The end-user selects his Favourites Hierarchy (which is itself a Workflow Application Document) from the list plus enters “http://dogs.com”
5. The resulting hierarchy is all the entries contained in the first two Workflow Application documents that contain the word ‘dog’, ‘dogs’ or like words but not if those entries already appearing in the Favourites Hierarchy or come from dogs.com.
6. The end user collapses all hierarchies not related to pet food
7. The end user flags all entries regarding dried food
8. The end user switches to the Flagged Folders and Entries Workflow Application Document
9. The end user sorts the entries by price and accesses the cheapest options
   Scenario 6
1. The end-user opens a previously created Workflow Document Application which contain search results from an area of continuing interest
2. The end-user presses the refresh button
3. The search is performed again, with the latest additions updated and highlighted. Items which are no longer found are also indicated as being no longer available or only available as cached archives.

Of course many different combinations of search activity are possible using the invention and the above scenarios in no way cover all of them. However what the invention provides is a much-improved way to obtain and evaluate search results, be they pertaining to documents or other content, catalogue items or even database entries.

No other search system provides the convenience of multi-engine locationally-based searches with the power of viewing, sorting and evaluating search results using Workflow Application Documents.

Deployment Models

The invention lends itself to many styles of deployment, including centralised on servers, client/server or desktop host models. Each has its own advantages and disadvantages, some which open up new business opportunities.

Finding information on one's own PC is sometimes difficult enough without the additional complexity of navigating networks. So a natural embodiment of the system is as a desktop application or embedded within or integrated with a knowledge worker's primary application, such as their word processor. In this way, the invention could seamlessly weave both local and networked environments together under a single search mechanism.

Depending on the style of embodiment, the system could be deployed with search engine companies as a fee-for-premium-search option. In this scenario, the Workflow Document Application and Query Entry modules could be made available as a downloadable applet, while the Search Engine Submitter and initial location analysis is performed by the search engine company. This configuration has the advantage of reducing the bandwidth requirement of the end-user, as only the final answers would be sent, not all the initial data from every search engine. Additionally, end-user interaction (on the client applet) could optionally be signalled back to the search engine company (or Workflow Document Applications themselves or their data could be sent from the client back up to the server), allowing a centralised store of Workflow Application Documents. Under this configuration, Workflow Application Documents could be accessible to end-users from any device, or even accessible by multiple end-users.

The above deployment method may also work well within organizations. Many of these may wish to conserve local area network bandwidth or run initial search aggregation processes on the fastest machines available, without having to upgrade desktops across the organization.

Highly centralised deployment is also possible using graphical terminal services and remote display protocols. This option may be attractive for supporting users with less powerful machines connected through low bandwidth networks, such as mobile devices using cellular telephone or satellite connections.

The centralised model will also be of interest to those publishing documents using remote display protocols as part of their copyright protection and maximised distribution. In this case, having such a powerful search tool will make it easier for end-users to locate the most relevant documents, leading to increased sales and advertising revenues.

Throughout the specification the aim has been to describe embodiments of the invention without limiting the invention to any specific combination of alternate features.

We claim:

1. A method of reporting search results including the steps of:
retrieving search results from one or more search engines;
filtering the retrieved search results according to one or more criteria;
extracting locational information from the filtered search results;
storing the locational information in one or more output hierarchies; and
displaying the search results within the one or more output hierarchies.

2. The method of claim 1 further including the step of transforming a search request to a form suitable for each of said one or more search engines.

3. The method of claim 1 further including the step of transforming said search results from said one or more search engines to a standardised form.

4. The method of claim 1 wherein the criteria for filtering includes removing duplicates.

5. The method of claim 1 wherein the step of extracting locational information includes the step of analyzing a URL of the search result.

6. The method of claim 1 wherein the step of extracting locational information includes the step of analyzing a file system location of the search result.

7. The method of claim 1 wherein the step of extracting locational information includes the step of analyzing a taxonomy of the search result.

8. The method of claim 1 wherein the one or more output hierarchies are constructed from the locational information.

9. The method of claim 1 further including the steps of retrieving further search results from one or more search engines and merging the search results to the one or more output hierarchies.

10. The method of claim 1 further including the steps of manipulating said output hierarchies to collapse, expand, move or flag said search results

11. The method of claim 1 further including the steps of adding notes and discussions to search results and/or hierarchies.

12. The method of claim 1 further including the steps of sorting and prioritising the search results within an output hierarchy or between output hierarchies.

13. The method of claim 1 further including the step of storing search results and hierarchies.

14. A method of compiling and presenting search results including the steps of:
defining search parameters for submission to one or more search engines;
passing the search parameters to a search engine submitter;
said search engine submitter transforming the search parameters to search terms for each of said one or more search engines;
receiving results from said one or more search engines;
said search engine submitter transforming said results into standardised results having a standardised format;
passing the standardised results to a location analyser;
said location analyser filtering the standardised results according to criteria to produce filtered results;
passing the filtered results to a hierarchical data modeller;
said hierarchical data modeller extracting locational information from said filtered results;
compiling said locational information in an output hierarchy; and
displaying the filtered results within the output hierarchy.

15. A search result reporting engine comprising:
a location analyser means that filters search results received from one or more search engines according to one or more criteria; and
an hierarchical data modeller means that extracts locational information from the filtered search results and compiles said search results into output hierarchies based upon the locational information.

16. The search result reporting engine of claim 15 further comprising a search engine submitter means adapted to accept a search query from a user and to submit the search query to one or more search engines.

17. The search result reporting engine of claim 15 further comprising a Report Renderer means that displays the search results within the output hierarchies.

18. The search result reporting engine of claim 15 further comprising means for manipulating said hierarchies to collapse, expand, move or flag said search results.

19. The search result reporting engine of claim 15 further comprising means for adding notes and discussions to search results and/or hierarchies.

20. The search result reporting engine of claim 15 further comprising a display means that sorts and prioritises the search results within a display hierarchy or between display hierarchies.

21. The search result reporting engine of claim 15 further comprising a search engine submitter means adapted to accept a search query from a user and to submit the search query to one or more search engines.

22. The search result reporting engine of claim 21 wherein search engine submitter reformats the search query for each search engine.

23. The search result reporting engine of claim 15 further comprising a storage means for storage of search results and hierarchies.

24. The search result reporting engine of claim 23 wherein the storage means provide the capacity to merge new results with stored results.

25. The search result reporting engine of claim 15 wherein the hierarchical data modeller comprises means for extracting location and meta information from a search engine result set; means for compiling the location and meta information into a N-way hierarchical storage location; and means for retrieving and displaying like information from the storage location.

26. An hierarchical data modeller comprising:
means for extracting location and meta information from a search engine result set;
means for compiling the location and meta information into a N-way hierarchical storage location; and
means for retrieving like information from the storage location.
